(19) United States
(12) Patent Application Publication
(10) Pub. No.: US 2006/0052917 A1
(43) Pub. Date: Mar. 9, 2006

(54) Device for evaluating and or influencing a motion variable and or motion behavior of a vehicle

(76) Inventors: Andreas Schwarzhaupt, Oberrot (DE); Gernot Spiegelberg, Heimsheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/497,229

(22) PCT Filed: Nov. 26, 2002
(86) PCT No.: PCT/EP02/13280

§ 371 Date: Sep. 7, 2005

(30) Foreign Application Priority Data
Nov. 29, 2001 (DE) 101 58 418.0

(51) Int. Cl. G01M 17/00

(52) U.S. Cl. 701/29; 701/35

(57) ABSTRACT

The device according to the invention relates to a device for evaluating and/or influencing a vehicle movement variable and/or the vehicle movement behavior. For this purpose, the device has the following means: operator control means (10) with which the driver can generate predefined values (VG) for influencing at least one vehicle movement variable. Evaluation means (42, 44, 46, 48) with which the behavior of a vehicle movement variable with respect to a predefined value is evaluated, and/or with which the vehicle movement behavior is evaluated with respect to a predefined vehicle movement behavior as a function of vehicle movement variables and/or of variables which represent the surroundings of the vehicle. These evaluation means (42, 44, 46, 48) can be operated in at least two different operating states, only an information item (OHAx) relating to the behavior of the vehicle movement variable and/or relating to the vehicle movement behavior being made available to the driver in a first operating state as a function of the result of the evaluation which is carried out, and output signals (AGSx) for influencing a vehicle movement variable and/or the vehicle movement behavior independently of the driver being determined in a second operating state as a function of the result of the evaluation which is carried out. In addition, the device has influencing means (40) by means of which the driver can switch over the evaluation means (42, 44, 46, 48) between the at least two operating states. There is also provision of processing means (12, 14, 16, 18, 20, 22) with which actuation signals (ASSx) for actuating actuators (26, 28, 30) which are arranged in the vehicle are generated on the basis of the predefined values (VG) which are generated by the driver and/or, if the evaluation means (42, 44, 46, 48) are operated in the second operating state, on the basis of the output signals (AGSx). The actuation of the actuator (26, 28, 30) influences the vehicle movement variable and/or the vehicle movement behavior.

### BACKGROUND AND SUMMARY OF THE INVENTION

The invention relates to a device for evaluating and/or influencing a vehicle movement variable and/or the vehicle movement behavior. The vehicle movement variable is a variable which describes and/or influences the movement of the vehicle.

As far as the basic method of operation is concerned, such devices are known in various modifications from the prior art. Examples are:
1) Parking aid systems for supporting the driver during a parking operation. The support is provided in the form of, for example, visual and/or audible signals which signal the distance between the vehicle and obstacles which are located in the surroundings of the vehicle during a parking operation.
2) Traction control systems (ASR) with which the drive wheels are prevented from spinning in the case of propulsion.
3) Brake slip control systems (ABS) with which the wheels of the vehicle are prevented from locking in the case of deceleration.
4) Vehicle movement dynamic control systems (ESP) with which the yaw rate of the vehicle is controlled, the yaw rate describing the rotational movement of the vehicle about its vertical axis.
5) Speed limiting systems with which the speed of the vehicle is limited to a predefinable value.
6) Speed control systems with which the speed of the vehicle is set to a predefinable value. These speed control systems can also be of an adaptive design.
7) Brake assistance systems with which the driver is supported in the braking operation when he wishes to brake the vehicle with a high degree of deceleration.

Such devices are generally known under the collective term “driver assistance systems”. Driver assistance systems are generally defined as follows: they are understood to be systems which support the driver in his driving task, relieve him of the need to perform routine tasks or serve to improve the safety and/or the comfort in terms of his driving task or are carried out using telematic apparatuses.

The device according to the invention can be used in x-by-wire systems (these are understood to include, for example, steer-by-wire, brake-by-wire or drive-by-wire systems). In such systems, the steering, braking and driving of a vehicle are controlled electronically without there being a continuous mechanical operative connection between the steering wheel and the steered wheels or between the accelerator pedal and an actuator means which is assigned to the engine and has the purpose of influencing the engine torque which is output by the engine, or without there being a continuous mechanical or hydraulic operative connection between the brake pedal and the wheel brake cylinders which are assigned to the individual wheels.

The device according to the invention is divided into a plurality of signal processing levels and has actuators, in particular for the brake system, steering system, engine and transmission, for implementing actuation signals.

With respect to the structure in a plurality of signal processing levels, reference is made to German laid-open patent application DE 41 11 023 A1, which discloses a control system for a vehicle structured in hierarchical levels which are run through in a predefined sequence during the signal processing. The signal processing for the areas of steering, wheel drive and chassis is carried out separately, as a result of which the signal processing path branches in the lower hierarchical levels resulting in a complex structure of the control system.

Further control systems which are divided into a plurality of signal processing levels are known from the following patent documents DE 197 09 319 A1, DE 198 38 336 A1, DE 197 09 318 A1, DE 198 38 333 A1 and WO 99/01320.

The devices for evaluating and/or influencing a vehicle movement variable and/or the vehicle movement behavior, which are known from the prior art, only permit the degree of support of the driver to be set in a restricted way.

At this point it is to be noted that wherever activation or deactivation is mentioned below, it is the activation or deactivation which is respectively performed by the driver that is meant.

If parking aid systems which are used today, i.e. are in series production in motor vehicles, are operated in the activated operating state, they only inform the driver about the vehicle movement behavior, in this case about the distance from objects in the surroundings in which the vehicle is to be parked, which distance results from the movement of the vehicle. The information is provided visually and/or audibly. Such parking aid systems can merely be deactivated. They can, for example, not be placed in an operating state in which they carry out interventions independently of the driver in order to carry out an automatic parking operation.

In the activated operating state, traction control systems carry out braking interventions and/or engine interventions in order to prevent the drive wheels from spinning in the case of propulsion. If interventions into the brakes and/or into the engine are carried out within the scope of the traction control, the driver is usually informed about this by means of a visual display. In the deactivated operating state, this function is no longer available, i.e. the drive wheels are not prevented from spinning in the case of propulsion, and only a brake slip control is still carried out. An operating state of the traction control in which the driver is merely informed without interventions being carried out independently of the driver is not provided. Within the scope of the traction control, the wheel slip which constitutes a variable which influences the vehicle movement is evaluated.

Brake slip control systems are permanently activated, they cannot be deactivated. An operating state in which the driver is merely informed without interventions being carried out independently of the driver is not provided. The wheels of the vehicle are prevented from locking in the case of deceleration by means of brake interventions with which the brake pressure which prevails in the wheel brake cylinder is reduced. The wheel slip is also evaluated within the scope of the brake slip control.

In the activated operating state, vehicle movement dynamic control systems carry out brake interventions and/or engine interventions. In particular, a yaw moment which acts on the vehicle and which counteracts an oversteering or understeering behavior of the vehicle is generated in particular by the brake interventions. The yaw rate of the vehicle is evaluated within the scope of the vehicle movement dynamic control. This is a variable which describes the vehicle movement. In the activated state, a traction control and a brake slip control are also simultaneously active. In the deactivated operating state, a yaw rate control is not carried out anymore, there is then only a brake slip control available. An operating state in which the driver is merely informed without interventions being carried out independently of the driver is not provided.

In the activated operating state, the speed of the vehicle, which constitutes a variable which describes the vehicle movement, is limited, using speed limiting systems, to a value which can be predefined by the driver. As long as the actual speed of the vehicle is less than the predefined value, a propulsion request of the driver is permitted. However, as soon as this value is reached, a propulsion request is no longer permitted. For this purpose, interventions are made, for example, in the engine management system. If the vehicle is equipped with an automatic transmission, interventions can also be carried out said automatic transmission. Such systems can only be deactivated. An operating state in which the driver is only informed without interventions being carried out independently of the driver is not provided.

In the activated operating state, speed control systems set the speed of the vehicle to a value which can be predefined by the driver. For this purpose, the torque which is output by the engine is usually set in such a way that the speed of the vehicle assumes the desired value. For this purpose, interventions are made, for example, in the engine management system. If the vehicle is equipped with an automatic transmission, interventions can also be made in said automatic transmission. Such systems can only be deactivated. An operating state in which the driver is only informed without interventions being carried out independently of the driver is not provided. The speed of the vehicle constitutes a variable which describes the vehicle movement.

As already mentioned, speed control systems can also be of an adaptive design. In this case, the driver predefines a value for the speed of the vehicle which is set by the system by means of brake interventions and/or engine interventions in the freewheeling mode. If the vehicle is equipped with an automatic transmission, interventions can also be made in said automatic transmission. Furthermore, the driver predefines a setpoint time interval which describes the chronological interval between his own vehicle and the vehicle traveling ahead. In the follow-on mode, the speed profile of the vehicle traveling ahead is simulated by means of interventions in the brakes and/or in the engine, and the predefined value for the setpoint time interval is set. In the case of an adaptive speed control, the vehicle movement behavior is influenced, said vehicle movement behavior being described by the speed of the vehicle and the distance from other vehicles participating in the road traffic. The distance data is considered as variables which represent the surroundings of the vehicle. Such systems can only be deactivated. There is no provision for information relating to the vehicle movement behavior to be displayed.

Brake assistance systems are permanently activated. They cannot be deactivated. Such systems support the driver in what are referred to as hazard or emergency braking operations. Evaluation of the activation of the brake pedal by the driver is used to determine whether support is necessary. For this purpose, for example the speed with which the brake pedal is activated is evaluated. If a hazard or emergency braking operation is detected, brake pressure is built up at the wheel brake cylinders in a supporting fashion in such a way that the wheels are made to approach the locking limit. These systems thus carry out an automatic braking operation in which the maximum vehicle deceleration which is possible owing to the present friction conditions between the wheel and underlying surface is set. An operating state in which the driver is only informed without interventions being carried out independently of the driver is not provided.

In the activated operating state, systems for acceleration control are also present in the vehicle, which generate actuation signals for the drive train (which comprises at least the engine and an automatic transmission), in such a way that a predefined vehicle acceleration is set. In a corresponding way, systems for deceleration control generate actuation signals at least for brake actuators which are assigned to the wheels, in such a way that a predefined vehicle deceleration is set. It is possible to provide for these systems to be deactivated. There is no provision for purely providing information.

In the activated state, systems for predictive speed adaptation generate actuation signals for the brakes and/or the engine and/or an automatic transmission in such a way that the speed of the vehicle is limited to a prescribed maximum speed. The maximum speed which is permitted in the individual sections of a route are provided to the system, for example suitable evaluation of images of the road signs positioned at the edge of the roadway or by reference to data which is made available by a navigation system. In addition, when determining the permitted maximum speed, it is possible to determine the profile of a bend which is to be traveled through, which can be determined, for example, using a GPS system or a digital map which is carried along in the vehicle, and/or the coefficient of friction which is determined for the respective section of the route. Such systems can be deactivated; there is no provision for purely providing information.

Using predictive emergency braking systems, the vehicle is braked in such a way that a collision is prevented in the case of suddenly occurring hazardous situations—these may arise, for example, when traveling in a column as a result of abrupt braking of the vehicle traveling ahead or as a result of an obstacle suddenly appearing in the driving path. Such systems can be deactivated. There is no provision for purely providing information. An emergency braking system is described, for example, in DE 196 47 430 C2, the content of which is intended to form part of the disclosure of the present application.

Automatic course-holding systems can be activated and deactivated. In the activated state, the course of the roadway is evaluated and steering interventions are carried out as a function thereof, with which interventions, if appropriate, steering predefined inputs of the driver are coordinated in order to keep the vehicle on the roadway. There is no provision for purely providing information.

As is apparent from the list above, in the case of driver assistance systems—within the scope of the present invention these are referred to as evaluation means—two different operating states can usually be set. However, there is no provision here for the same evaluation means only to make available information to the driver in a first operating state, i.e. for it to operate exclusively in an assisting fashion, or for said evaluation means to generate, in a second operating state, output signals for influencing a vehicle movement variable—i.e., a variable which describes and/or influences the vehicle movement—and/or the vehicle movement behavior, independently of the driver. There is no provision for the degree of support of such evaluation means to be set as desired.

Against this background, the invention is based on the following object: the evaluation means which are used in vehicles, referred to as driver assistance systems, are to be improved with respect to the possibility of setting the degree of support which they provide to the driver.

This object is achieved by providing a device for evaluating and/or influencing a vehicle movement variable and/or the vehicle movement behavior, the device including: (a) operator control means with which the driver can generate predefined values for influencing at least one vehicle movement variable; (b) evaluation means with which the behavior of a vehicle movement variable is evaluated with respect to a predefined value, and/or with which the vehicle movement behavior is evaluated with respect to a predefined vehicle movement behavior as a function of vehicle movement variables and/or of variables which represent the surroundings of the vehicle, these evaluation means being capable of being operated in at least two different operating states; (c) an information item relating to the behavior of the vehicle movement variable and/or relating to the vehicle movement behavior being made available in a first operating state to the driver as a function of the result of the evaluation which is carried out, and output signals for influencing a vehicle movement variable and/or the vehicle movement behavior independently of the driver being determined in a second operating state as a function of the result of the evaluation which is carried out; (d) influencing means by which the driver can switch over the evaluation means between the at least two operating states; and (e) processing means with which actuation signals for actuating actuators which are arranged in the vehicle are generated on the basis of the predefined variables which are generated by the driver and/or, if the evaluation means are operated in the second operating state, on the basis of the output signals, the vehicle movement variable and/or the vehicle movement behavior being influenced by the actuation of the actuators.

In a device according to the invention for evaluating and/or influencing a vehicle movement variable, i.e. a variable which describes and/or influences the vehicle movement, and/or the vehicle movement behavior, operator control means are firstly provided with which the driver can generate predefined values for influencing at least one vehicle movement variable. The operator control means is, for example, a steering wheel and/or a side stick and/or an accelerator pedal and/or a brake pedal. Predefined variables to be considered are the steering wheel angle and/or the adjustment path of the side stick and/or the pedal angle or the pedal travel by which a pedal is deflected. The variables which describe the vehicle movement are, for example, the steering angle, the yaw rate, the speed of the vehicle, the deceleration of the vehicle or the acceleration of the vehicle. The variables which influence the movement of the vehicle are, for example, the brake pressure, the wheel slip or the engine speed. These examples are not definitive and further variables may be added, as is apparent from the following explanations.

For the evaluation means or the degree of support to be able to be set in a wide range, these evaluation means must be correspondingly configured. For this purpose, the following configuration has proven particularly advantageous.

The evaluation means with which the behavior of a vehicle movement variable with respect to a predefined value is evaluated and/or with which the vehicle movement behavior is evaluated with respect to a predefined vehicle movement behavior as a function of vehicle movement variables and/or of variables which represent the surroundings of the vehicle, must be capable of operating in at least two different operating states. In order to be able to set a wide range of the degree of support, all that is necessary is for information, relating to the behavior of the vehicle movement variable and/or relating to the vehicle movement behavior, to be made available to the driver in a first operating state as a function of the result of the evaluation which is carried out, and for output signals for influencing a vehicle movement variable independently of the driver, and/or the vehicle movement behavior to be determined in a second operating state as a function of the result of the evaluation which is carried out. The vehicle movement variables comprise variables which describe and/or influence the vehicle movement.

The variables which describe the vehicle movement are, for example, the vehicle speed (speed limiting systems, speed control systems, systems for predictive speed adaptation) or the yaw rate of the vehicle (vehicle movement dynamic control systems) or the deceleration of the vehicle (system for deceleration control) or the acceleration of the vehicle (system for acceleration control). The variables which influence the vehicle movement are, for example, the wheel slip (traction control systems, brake slip control systems) or the pedal travel or the deflection angle of the brake pedal or its deviation over time (brake assistance systems). The vehicle movement behavior is evaluated in parking aid systems or in adaptive speed control systems or in predictive emergency braking systems or in automatic course-holding systems.

So that the evaluation means can be switched over, influencing means are to be provided by which the driver can switch over the evaluation means between the at least two operating states. As a result, it is possible to switch over between merely conveying information, a first operating state, and influencing, as is carried out in the second operating state. At this point reference will be made to FIG. 2. The operating state of purely conveying information is designated in FIG. 2 with the numeral 2. The operating state of influencing is designated in FIG. 2 by the numerals 3, 4 and 5. There is provision for the respective operating state to be maintained until the driver sets another by appropriately activating the influencing means.

Processing means have to be provided to enable the evaluation means, if they are operated in the second operating state, to exert an influence. Actuation signals for actuating actuators which are arranged in the vehicle are generated with said means on the basis of the predefined variables which are generated by the driver and/or, if the evaluation means are operated in the second operating state, on the basis of the output signals. The vehicle movement variable and/or the vehicle movement behavior are influenced by actuating the actuators.

A plurality of sub-operating states of the evaluation means can advantageously be selected in the second operating state of the evaluation means by using the influencing means. It has proven advantageous here to have a division into at least three sub-operating states. These sub-operating states differ from one another in the priority relationship between the output signals and the predefined values in the determination of the actuation signals. That is to say, in a sub-operating state the output signals have a higher priority than the predefined values and are thus taken into account with preference in the determination of the actuation signals. In another sub-operating state, the priority relationship is completely reversed. As a result of the fact that at least three sub-operating states can be selected, it is possible to implement a large degree of variability in the support of the driver by the evaluation means.

The driver can advantageously select between two operating modes in a first sub-operating state. The first operating mode is one in which the output signals are not taken into account in the generation of the actuation signals, or the determination of the output signals is suppressed so that they are not at all available for the generation of the actuation signals. In this first operating mode, only the predefined variables are included in the generation of the actuation signals, the evaluation means are, as it were, “switched off”. In a second operating mode, in which the output signals are taken into account in the generation of the actuation signals, the predefined values basically have priority over the output signals in the generation of the actuation signals unless a predefined first situation is present in which the output signals then have priority over the predefined values. The evaluation means are, as it were, “active in a way which can be overridden”. The first sub-operating state is designated by the numeral 3 in FIG. 2.

The predefined first situation is preferably present if the vehicle movement variable deviates from the predefined value to a predefined degree and/or if the vehicle movement behavior deviates from the predefined vehicle movement behavior to a predefined degree. In a traction control system, the first situation is present if the wheel slip, to be more precise the drive slip, exceeds a predefined threshold value; in the case of a vehicle movement dynamic control system if the yaw rate exceeds a setpoint value; in the case of a speed limiting system if the vehicle speed exceeds a predefined value. The operation of parking aid systems, speed control systems (adaptive or not adaptive), automatic course-holding systems, systems for acceleration control or deceleration control, systems for predictive speed adaptation and predictive emergency braking systems in the first sub-operating state is contemplated. In a parking aid system, the first situation is present if, for example, a setpoint trajectory, which predefines the optimum profile of the parking path, is departed from; in an automatic course holding system if, for example, a minimum distance from the edge of the roadway is undershot; in a speed control system and a system for predictive speed adaptation if the speed of the vehicle is higher than the value predefined for it, in the case of an adaptive system, if the distance from the vehicle traveling ahead undershoots a predefined value; in a system for acceleration control or for deceleration control if there is a deviation from the value of the acceleration or deceleration which is to be set; and in a predictive emergency braking system if, for example, a condition which is defined by the distance between the driver's own vehicle and a vehicle traveling ahead and the relative speed between these two vehicles, is fulfilled.

A brake slip control system or a brake assistance system therefore tends not to be suitable for operation in a first sub-operating state since the functions here are ones which should be permanently available to the driver. Nevertheless, at this point it is to be noted that the first situation is present in a brake assistance system if the value for the pedal deflection angle and/or the pedal deflection angular speed are higher than a threshold value, and is present in a brake slip control system if the wheel slip, to be more precise the brake slip, exceeds a predefined threshold value.

In a second sub-operating state, the output signals basically have priority over the predefined values in the generation of the actuation signals unless a predetermined second situation is present in which the predefined values then have priority over the output signals. That is to say the evaluation means are active but the driver can override them. This second sub-operating state is designated by the numeral 4 in FIG. 2.

In accordance with the above statements in conjunction with the first sub-operating state, it is to be noted that both the brake slip control system and the brake assistance system tend not to be suitable for operation in a second sub-operating state.

The predefined second situation occurs if the driver activates one of the operator control means in a fashion which is characteristic of the second sub-operating state. For example, the driver can override a speed limiting system by activating the acceleration pedal in the manner of a kick down, as a result of which it is possible to reach a higher speed of the vehicle than is present while the speed limiting system is operating. The same applies to a speed control system. A system for predictive speed adaptation can also be overridden in accordance with the statements above. A predictive emergency braking system, which is to be activated with the consent of the driver, can be overridden for example as a function of whether the driver initiates a steering operation and/or a braking operation. A traction control system can be overridden by the driver by suitably activating the accelerator pedal. A parking aid system can be overridden by the driver by means of a steering intervention.

In a third sub-operating state, the predefined variables are not taken into account in the generation of the actuation signals. The output signals are advantageously determined redundantly in this third sub-operating state and the actuation signals are determined on the basis of these redundantly determined output signals. In the third sub-operating state, the actuation signals are generated independently of the driver using autonomously operating evaluation means which are of redundant and, if appropriate, fault-tolerant configuration. The third sub-operating state corresponds to the fifth case illustrated in FIG. 2.

Actuators for the brake system and/or steering system and/or engine and/or transmission are advantageously provided as actuators.

The device according to the invention is advantageously divided into individual signal processing levels.

An input level to which the operator control means with which the driver can continuously make predefined inputs which are converted into predefined values are assigned, and to which the influencing means are assigned.

A predictive level with first processing means for correcting the predefined values by means of a prediction of driving states which is made by first evaluation means. Evaluation means which are arranged in this predictive level may be, for example, a predictive stability monitoring system and/or a system for predictive speed adaptation.

A reactive level with second processing means for correcting the predefined values by means of current driving states which are determined by second evaluation means. Evaluation means which are arranged in this reactive level may be, for example, vehicle movement dynamic control systems which make interventions in the engine and/or in the brakes and/or in the steering system in order to stabilize the vehicle, and/or brake slip control systems and/or traction control systems.

A coordination level with third processing means for converting the predefined values into actuation signals.

An execution level with the actuators for executing the actuation signals.

As a result of this signal processing level structure, a simple, modular structure is provided in which individual signal processing levels, for example the predictive level, can be omitted—if its functionality is not required—without having to give up the basic structure of the control system. This provides an extremely flexible control system. Providing a coordination level for converting the setpoint value signals into actuation signals provides a defined interface with which the levels in which the original predefined inputs are processed are decoupled from the levels in which the processed predefined inputs are executed. Such a defined interface simplifies the structure and makes amendments and extensions to the control system considerably easier. Moreover, redundant signal processing and fault-tolerant and redundant data transmission provide a high degree of fail safeness of the control system. The bidirectional data processing between successive signal processing levels, that is to say also between the actuators and the coordination level, permits setpoint value signals to be transmitted and actual value and diagnostic value signals to be fed back.

It is advantageous here if the devices for bidirectional data transmission are embodied as optical waveguides. High-speed data transmission, which is comparatively independent of external interfering influences, can be achieved by means of optical waveguides.

At this point the term “bidirectional data transmission” will be explained. On the one hand, this term is used in its actual sense. Specifically to mean that data is transmitted in both directions using a single transmission device, for example a data line or a bus system. On the other hand, the term means that the bidirectional data transmission is carried out using two unidirectional transmission devices. Here, the data is transmitted in one direction using one unidirectional transmission device and in the other direction using the other device.

In a development of the invention, the reactive level is arranged between the coordination level and the execution level. As a result, the actuation signals for the actuators are corrected by means of current driving states. This may be advantageous with respect to a rapid reaction to critical driving states since the actuation signals for the actuators are corrected immediately.

A reactive processing means for reacting to critical current driving states is advantageously assigned directly to at least one actuator. This embodiment of the invention is also advantageous with respect to a rapid reaction to critical driving states. As a result, for example, an anti-lock brake system can be assigned directly to the wheel brake.

As a developing measure there is provision for apparatuses for supplying power to be embodied redundantly for all the signal processing levels. This measure contributes to a considerably increased fail safeness of the control system.

In a further development of the invention, there is provision for in each case at least two physically separate first, second or third processing means for redundant signal processing to be provided in the predictive level, the reactive level and the coordination level. Such hardware redundancy improves the reliability of the control system.

As another developing measure, there is provision for the software to be embodied redundantly in the first, second and third processing means. As a result, the reliability of the control system is further improved.

The actuators are advantageously connected to the third processing means and to one another by a fault-tolerant, redundant and bidirectional data bus, and the first, second and/or third processing means are suitable for redundant signal processing, and apparatuses for fault-tolerant, redundant and bidirectional data transmission are provided between two successive signal processing levels.

At this point an explanation will be given of the terms fault tolerance and redundancy which are used. Fault tolerance refers to the capability of a system to fulfill its specific function even with a limited number of faulty subsystems. Redundancy is understood as the presence of more than the means which are necessary per se for carrying out the tasks provided.

### BRIEF DESCRIPTION OF THE DRAWINGS

Further features and advantages of the invention emerge from the following description in conjunction with the appended drawings, in which:

FIG. 1 is a schematic illustration of the device according to the invention;

FIG. 2 is a schematic illustration of the operating states and sub-operating states and operating modes which are provided for the evaluation means; and

FIG. 3 is a schematic illustration of the method according to the invention, which takes place in the device according to the invention.

### DETAILED DESCRIPTION OF THE DRAWINGS

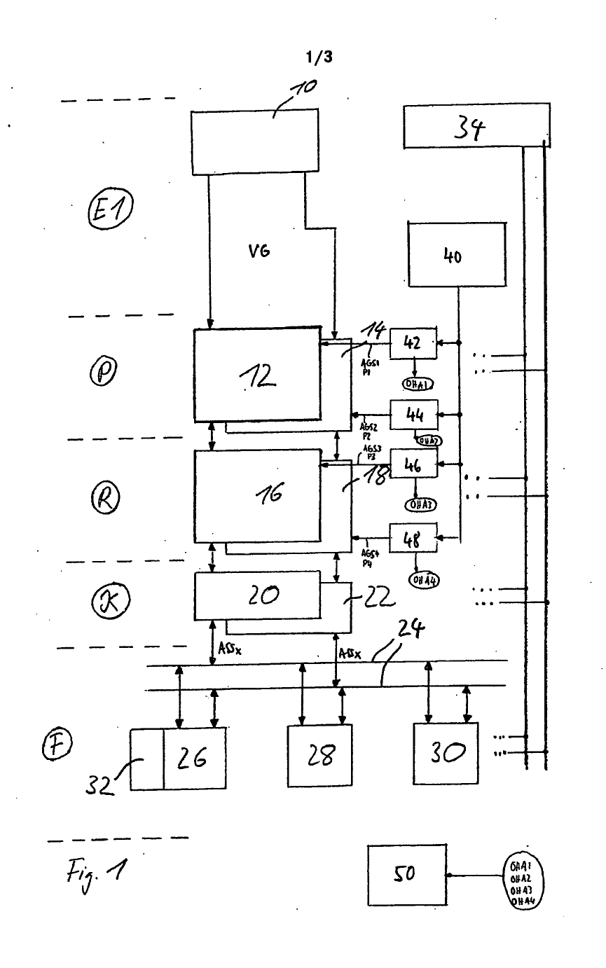

In the schematic illustration in FIG. 1, a plurality of signal processing levels can be seen. In one input level E1, a driver uses operator control means 10 to continuously make predefined inputs for the movement of the vehicle which are made available in the form of predefined values VG. By activating operator control elements, for example a side stick or accelerator pedal, brake pedal and steering wheel or else only keeping said elements in a specific position, the driver predefines continuously, viewed over time, how the vehicle is to move. At least one vehicle movement variable is influenced by these predefined inputs.

The predefined values which are generated from the continuous predefined inputs of the driver are fed to a predictive level P, to be more precise to first processing means 12 and 14, which are arranged in the predictive level. The predefined values VG are corrected in the first processing means 12 and 14 taking into account a prediction of driving states. This prediction of driving states is made by first evaluation means 42 and 44. The evaluation means 42 is assigned to the processing means 12 and the evaluation means 44 is assigned to the processing means 14.

One of the two operating states, or one of the three sub-operating states, is selected for the two first evaluation means 42 and 44 by influencing means 40. The processing means 12 and 14 are informed by the values P1 and P2 as to which of the three sub-operating states is selected. This information is important for the processing means 12 and 14 because it tells them the priority relationship between the predefined values VG and the output signals AGS1 and AGS2 which are generated by the evaluation means 42 and 44.

If the evaluation means 42 and 44 are operated in the first operating state in which there is only provision for information to be supplied to the driver, the first evaluation means 42 and 44 then only respectively generate the variables OHA1 and OHA2 which are fed to a block 50. Block 50 represents a device which is used to inform the driver visually and/or audibly and/or haptically about the behavior of the vehicle movement variable and/or about the vehicle movement behavior so that he can make interventions, if appropriate. In the first operating state, the first evaluation means 42 and 44 do not output any output signals AGS1 and AGS2 to the processing means 12 and 14 since there is no provision for interventions to be carried out independently of the driver in this operating state. The variables P1 and P2 are nevertheless fed to the processing means 12 and 14 in order to inform them that the predefined values are to be used exclusively in this case.

If the evaluation means 42 and 44 are operated in one of the sub-operating states of the second operating state in which there is provision for the interventions to be carried out independently of the driver, the output signals AGS1 and AGS2 and the signals P1 and P2 are then output to the first processing means by the evaluation means 42 and 44.

A prediction of driving states is made, for example, by a predictive system which is present in the vehicle and has the purpose of avoiding critical driving states. Such a system warns, for example, when there is an excessively high speed for an imminent bend or even brakes the vehicle (system for predictive speed adaptation). The radius of the bend may be determined, for example, using GPS (Global Positioning System) and a road map, and further diagnostic signals can come from sensors for sensing the state of the road.

Further possible predictive evaluation means are, for example, parking aid systems, speed limiting systems, speed control systems (adaptive or not adaptive), systems for predictive stability monitoring and systems for predictive speed adaptation. This list does not have a definitive character. In general terms it contains evaluation means with which the surroundings are evaluated.

As is apparent in FIG. 1, the predefined values are fed to the processing means 12 and 14 via separate data lines. The processing means 12 and 14 are separated physically here. The signal processing is then carried out redundantly both in the processing means 12 and in the processing means 14. The first evaluation means 42 and 44 are also of redundant configuration. As a result, the function of the predictive level P is ensured even when one of the means 12 or 14, or respectively 42 or 44 fails.

From the processing means 12 and 14 of the predictive level P, the predefined values which are possibly corrected there are transmitted into a reactive level R to processing means 16 and 18 there. In the reactive level R, system functions, which react to critical driving states of the vehicle, are executed in evaluation means 46 and 48. Such system functions are, for example, vehicle movement dynamic control systems, traction control systems, brake slip control systems or control systems within the scope of a brake assistance system.

The second evaluation means 46 and 48 can also be operated in at least two operating states, and in the case of the second operating state in at least three sub-operating states which the driver can select using the influencing means 40.

The significance of the signals OHA3, AGS3 and P3 for, and the determination of the signals OHA3, AGS3 and P3 by the evaluation means 46 can be inferred from the statements relating to the evaluation means 42 and 44 since the underlying content is identical. The same applies to the evaluation means 48 and the associated signals AGS4, P4 and OHA4.

The predefined values VG are corrected in the processing means 16 and 18 if the evaluation means 46 and 48 signal a requirement by means of the signals P3 and P4 in conjunction with the signals AGS3 and AGS4. In this context, the evaluation means 46 are assigned to the processing means 16, and the evaluation means 48 are assigned to the processing means 18.

From the reactive level R, the possibly corrected predefined values are then fed to a coordination level K, which includes third processing means 20 and 22. In the third processing means 20 and 22, the predefined values VG, which have possibly been corrected twice, are converted into actuation signals ASSx.

These actuation signals ASSx are transmitted from the coordination level K via a fault-tolerant, redundant and bidirectional data bus 24 to actuators 26, 28 and 30 which lie in an execution level F. The actuator 26 is assigned here to the vehicle brake system, the actuator 28 is assigned to the steering system and the actuator 30 is assigned to the engine and transmission of the vehicle. In the execution level F, the actuation signals ASSx are executed by the actuators 26, 28 and 30. In the schematic illustration in FIG. 1, only one actuator 30 for the engine and transmission is provided for the sake of simplification. In fact, a plurality of, possibly different actuators may be provided for the engine and transmission, in which case actuators which are not critical for safety, for example for the engine, do not necessarily need to be connected to a redundant data bus since connection to a simple data bus is sufficient for actuators which are not critical for safety.

A reactive processing means 32, which is assigned directly to the actuator 26, which is provided for the vehicle brake system, is also arranged in the execution level F. This processing means 32 implements the function of an antilock brake system, i.e. of a brake slip control system, and is arranged in the execution level F in order to bring about short signal processing times and signal transient times, and is directly assigned to the actuator 26.

FIG. 1 also shows an on-board power system 34, which is provided for supplying power to the individual levels E1, P, R, K and F. The power supply is embodied redundantly here so that a high degree of reliability is achieved. However, in the illustration in FIG. 1, the power supply to the individual processing means 12 to 20 and to the actuators 26 to 30 is indicated only by dots which are intended to represent the continuation of the power supply lines.

The data transmission between the processing means of the predictive level P, the reactive level R and the coordination level K takes place in a fault-tolerant, redundant and bidirectional fashion. While setpoint value signals are transmitted from top to bottom, i.e. for example from the predictive level P to the reactive level R and the coordination level K in FIG. 1, actual value signals and diagnostic value signals are transmitted in the opposite direction. Actual value signals and diagnostic value signals are also transmitted from the actuators 26, 28 and 30 arranged in the execution level F to the processing means 20 and 22 of the coordination level K via the bus 24.

As a result, all the data transmissions between the levels P, R, K and F take place in a fault-tolerant, redundant and bidirectional fashion. The lines used for the data transmission may be electrical leads or optical guides, for example glass fiber.

As an alternative to the illustration in FIG. 1, it is possible to provide, instead of the operator control means 10, an autonomous driving system which, instead of continuous values, predefines discrete values, for example an instruction “drive from A to B using destination coordinates”. The autonomous driving system is located in the input level E1 corresponding to the operator control means 10. In the case of an autonomous driving system, it is necessary to ensure that the discrete values are converted in such a way that the means which are present owing to the use of operator control means can operate satisfactorily.

The signal processing sequence in the embodiment in the input level E1, the predictive level P, the reactive level R, the coordination level K and the execution level F shown in FIG. 1 is defined and cyclic processing takes place in a fixed clock cycle.

However, embodiments of the control system in which the reactive level R is only arranged below the coordination level K are possible. The correction using current driving states is then carried out by processing the actuation signals which are generated in the coordination level K. Such a procedure may be advantageous with respect to rapid reaction to current driving states since the actuation signals are corrected directly and it is not necessary to wait firstly for the signal processing of the coordination level K.

An improvement of the reliability of the control system illustrated in FIG. 1 is achieved by a redundant embodiment of the software in the processing means 12, 14, 16, 18, 20 and 22. On the one hand, the results of the signal processing can thus be checked, and on the other hand, the function of the control system is still ensured even when there is a partial failure of the software.

At this point, the following should be noted: it is contemplated to provide evaluation means only in the predictive level or only in the reactive level, or in both levels simultaneously. This is possible since the device according to the invention is constructed in signal processing levels. As a result of the fact that evaluation means are provided in the various levels as desired, the device can be configured as desired and adapted to the requirements of the driver.

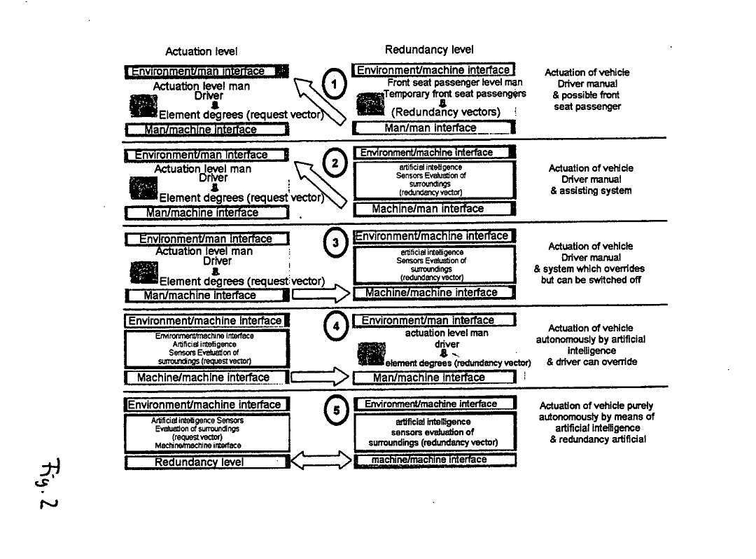

FIG. 2 is described below. In the figure, five possible configurations for the interaction between the driver and driver assistance system are illustrated.

First, the term used in FIG. 2 will be explained.

Environment/man interface (UMeS): the person perceives the environment by acquiring information from it or about it through the sense of sight, hearing, touch.

Actuation level man: the person processes the impressions perceived via the UMeS and converts them into movements of his limbs. This leads, for example, to activation of operator control means which are arranged in the vehicle.

Man/machine interface: via this interface the person can intervene in the movement behavior of the vehicle. Here, for example, the side stick and/or steering wheel and/or accelerator pedal and/or brake pedal operator control means. Further contemplated operator control means are remote control systems which can be used during a maneuvering operation during which the driver is located outside the vehicle.

Environment/machine interface (UMaS): via this interface, the machine acquires its information about the environment. These may be, for example, optical sensors such as, for example, camera systems or lasers, or ultrasonic sound sensors, telemetry systems, or means for sensing the present coefficient of friction of the roadway.

Artificial intelligence: this term indicates that the machine can convert the information acquired via the UMaS into an evaluation of the surroundings and can make conclusions therefrom. These conclusions cannot only lead to actuation of actuators, but they can also cause information to be made available to the driver. The information is output via the respective interface.

Man/man interface: via this interface, the driver communicates with a front seat passenger who is possibly present. The communication can be made by means of language, for example.

Machine/man interface: via this interface, the machine can provide the person with information. This can take place, for example, audibly and/or visually and/or haptically.

Machine/machine interface: via this interface, for example, the actuation signals which are necessary for influencing the vehicle movement variable and/or the vehicle movement behavior independently of the driver are passed on to the associated actuators.

The term request vector is used in the actuation level and the term redundancy vector is used in the redundancy level. These vectors include, on the one hand, the vehicle movement variable and, on the other hand, the vehicle movement variables and/or the variables which represent the surroundings of the vehicle and as a function of which the vehicle movement behavior is evaluated.

The individual cases which are illustrated in FIG. 2 can be described as follows:

Case 1: technically a driver assistance system is not present in this case. This would also correspond to the case in which the driver had completely switched off the a driver assistance system which is present. The driver perceives the environment and, on the basis of this perception, makes decisions which form the basis for the activation of the operator control means. The front seat passenger also perceives the environment and makes decisions on the basis of this perception. On the basis of these decisions, the front seat passenger communicates with the driver and as a result performs the function of a driver assistance system. The front seat passenger informs the driver, for example, about the course of the road or about applicable speed limits, etc.

Case 2: the actuators which are arranged in the vehicle are actuated in accordance with the predefined inputs of the driver. The driver assistance system only makes information available to the driver, it does not intervene in the actuators. In accordance with case 1, the driver perceives the environment and, on the basis of this perception, makes decisions which form the basis for the activation of the operator control means. The system also perceives the environment and makes decisions on the basis of this perception. The system communicates with the driver on the basis of these decisions. The system is configured as an assisting system and the actual predefined inputs come from the driver. Consequently, the system generates a redundancy vector. The present case 2 corresponds to the first operating state. In this operating state, it is possible, for example, for a parking aid system, which is used in series production in contemporary vehicles, to be operated. The same applies also to an automatic course holding system, a system for predictive speed adaptation or a predictive emergency braking system.

Case 3: the driver also perceives the environment in the present case and, on the basis of this perception, makes decisions which form the basis for the activation of the operator control means. The driver assistance system also perceives the environment and makes decisions on the basis of this perception. On the basis of these decisions, the system carries out interventions independently of the driver and/or influences setpoint values if there is a reason to do so owing to the vehicle behavior. The driver assistance system can be switched off by the driver if he does not desire its support. As long as the driver assistance system is not switched off, i.e. it is active, it overrides the driver if the driving situation requires so. The driver assistance system intervenes actively in the driving behavior of the vehicle by changing the request vector predefined by the driver. If the driver assistance system is switched off, the predefined inputs originating from the driver are implemented without modification. The driver assistance system generates a redundancy vector since the actual predefined inputs come from the driver. An example of a driver assistance system which can be operated in this way is a traction control system, a vehicle movement dynamic control system, a parking aid system, an automatic course holding system, a system for predictive speed adaptation, a predictive emergency braking system, a speed limiting system, or a speed control system. The present case 3 corresponds to the first sub-operating state of the second operating state.

Case 4: in the present case, the driver assistance system perceives the environment and makes decisions on the basis of this perception. On the basis of these decisions, the system carries out interventions independently of the driver and/or influences setpoint values. The driver also perceives the environment and, on the basis of this perception, he makes decisions which form the basis for the activation of the operator control means—if there is reason to do so in his opinion—and as a result, if appropriate, overrides the driver assistance system. The driver assistance system can no longer be deactivated by the driver, it is permanently active. However, he can override it if it is necessary to do so in his opinion. Consequently, the driver generates a redundancy vector; the actual predefined inputs come from the driver assistance system. As long as the driver does not intervene in an overriding fashion, the driver assistance system operates autonomously. In this case, the driver assistance system uses the partial automation of the vehicle, which can however be overridden at any time by the driver. An example of a driver assistance system which can be operated in such a way is a parking aid system, an automatic course holding system, a system for predictive speed adaptation, a predictive emergency braking system, a speed limiting system, or a speed control system. The present case 4 corresponds to the second sub-operating state of the second operating state.

Case 5: in this case, two redundant driver assistance systems are present, which operate autonomously and independently of the driver. The driver cannot override them. Both driver assistance systems each independently perceive the environment and independently make decisions on the basis of these perceptions. These decisions are compared with one another in order to determine whether they are plausible. When plausibility is present, interventions are carried out independently of the driver and/or setpoint values are influenced on the basis of these decisions. If there is no plausibility for this, the interventions or the influencing of the setpoint values do not take place. This procedure provides pure automation in a redundant embodiment. An example of such a driver assistance system which can be operated in such a way is a parking aid system, an automatic course holding system, a system for predictive speed adaptation, a predictive emergency braking system, a speed limiting system, a speed control system, a brake slip control system, or a brake assistance system.

The present case 5 corresponds to the third sub-operating state of the second operating state.

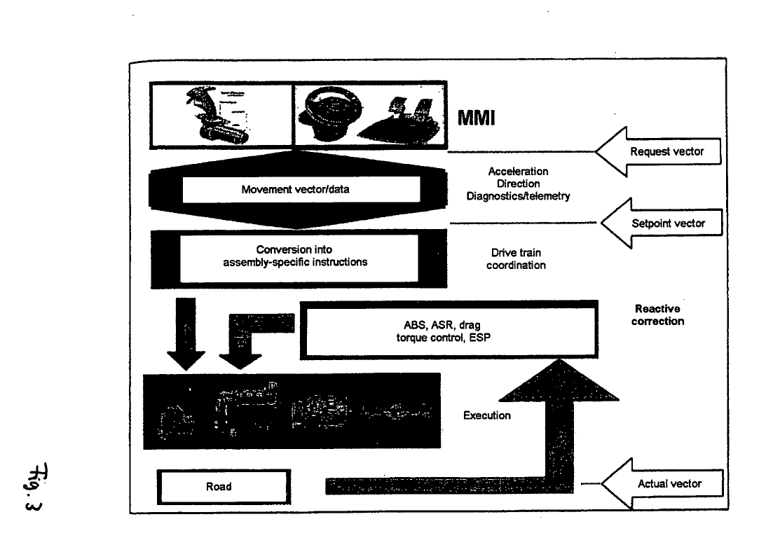

FIG. 3 will be described below.

MMI (man/machine interface) refers to the operator control means, i.e. a side stick, steering wheel, accelerator pedal, or brake pedal. By activating the operator control means, the driver generates a request vector which contains the predefined values. In a first alternative, the request vector contains information about the desired acceleration of the vehicle, which may be positive or negative, and about the desired steering angle. In a second alternative, the request vector contains information about the desired speed of the vehicle or acceleration of the vehicle and the desired steering angle. In general terms, the MMI are activation elements by which the driver can influence the movement behavior of the vehicle.

In a subsequent level, the predictive level, a setpoint vector is generated from the request vector. This conversion is carried out as a function of output signals which are generated by evaluation means which are arranged in the predictive level. According to the representation in FIG. 1, these are the output signals AGS1 and AGS2, which are generated by the evaluation means 42 and 44. The request vector is converted into a setpoint vector on the basis of an evaluation of the surroundings. The evaluation of the surroundings may include determining whether a child jumps onto the road, or detecting the speed which is permitted in the section of road which is currently being traveled along. Likewise, it is possible to take into account results which arise from diagnostics and/or telemetry. The diagnostics may be performed here in a known fashion onboard in the vehicle or externally. For example, a carrying agent can interrogate the current consumption of fuel or the date when the next inspection is due. The telemetry can be used for purposes of considering the surroundings. That is to say, the evaluation means intervene actively in the behavior of the vehicle in that the request vector, which is predefined by the driver, is changed.

In the following level, the drive train coordination, the setpoint vector is converted into assembly-specific instructions which are applied to the vehicle brakes, the engine, the transmission and/or the steering system. This takes place in the processing means 20 and 22 illustrated in FIG. 1.

Reactive correction can be carried out using evaluation means which are arranged in a reactive level. These are the processing means 16 and 18, which are illustrated in FIG. 1. For this purpose, measured values are fed to these evaluation means, which may be traction control systems, brake slip control systems, vehicle movement dynamic control systems, a drag torque control system or an extended vehicle movement dynamic control system in which not only intervention in the brake system and/or in the engine but also interventions in the steering system are carried out. These measured values may be, for example, the wheel speeds or rotation speeds of the wheels, the yaw rate of the vehicle, the steering angle, the transverse acceleration, the engine speed, the speed of the vehicle and/or the acceleration of the vehicle. At this point, it is to be noted that the actual vector preferably has the same components as the request vector. Output signals AGS3 and AGS4, which are also fed to the individual assemblies, are determined in accordance with the control algorithm which is stored in the respective evaluation means. As a result, a reactive correction is carried out, i.e. changes are made to the actuation on the basis of the reaction of the vehicle which is also influenced under certain circumstances by the road conditions. The reaction of the vehicle is described by the actual vector.

The actual state is fed back. The individual control concepts result in a reactive correction, specifically by virtue of the fact that the setpoint vector (represented by arrow 1) is compared with an actual vector (arrow 2, starting from the road), and the result of this comparison is also fed to the actuators (represented by the arrow 2 starting from the block ABS, ARS, drag torque control, ESP).

It is to be noted that the level structure illustrated in FIG. 3 can be considered as a sequence with which individual steps, which are each associated with one of the illustrated levels, are to be processed. This enables a method sequence to be generated. The same also applies to the illustration in FIG. 1.

In addition it is to be noted that advantageous configurations which may be obtained and which are based on a structural difference between FIG. 3 and FIG. 1 are considered to be disclosed. An example of this is the parallel access of the drive train coordination and of the reactive correction to the assemblies which is shown in FIG. 3.

According to the invention, there is provision for the mode of operation of the driver assistance systems, i.e. of the evaluation means, to be influenced by the driver within the scope of the cases 2 to 5 which are illustrated in FIG. 2. Alternatively, it is also possible to provide for influence to be exerted within the scope of cases 1 to 5. That is to say, starting at case 1, in which the driver does not experience any support, not even in the provision of information, extending to case 5, the purely autonomously operating driver assistance systems.

A driver assistance system which can have the operating mode range illustrated in the exemplary embodiment, specifically the operation according to cases 2 to 5, is, for example, a parking aid. Starting with the mere provision of information about the distance from obstacles (case 2 in FIG. 2), and extending to the correction of the driver, which may possibly be necessary but can be switched off (case 3 in FIG. 2), the execution of a parking operation under the supervision of the driver (case 4 in FIG. 2) and the execution of an autonomous parking operation which does not require monitoring by the driver (case 5 in FIG. 2).

The same can also be implemented for a speed control system, a speed limiting system, an automatic course holding system, a system for predictive speed adaptation or a predictive emergency braking system.

At this point, it is to be noted that the individual steps of the method according to the invention, which take place in the device according to the invention, are also considered to be disclosed by the present description. In addition, it is to be noted that the illustration or embodiment selected in the description or in the drawings is not intended to have any restrictive effect on the method according to the invention or the device according to the invention.

It is also to be noted here that a vehicle in which the device according to the invention is used can be equipped with a hydraulic or an electrohydraulic or a pneumatic or an electropneumatic or an electromechanical brake system. That is to say, the use of the terms brake pressure or wheel brake cylinder is not intended to have any restrictive effect. If another brake system is used, these terms are to be replaced by the terms to be used in this case.

By virtue of the fact that the driver can determine the operating state or the sub-operating state in which the evaluation means operate, he can decide himself how far the assistance provided by the vehicle assistance systems is to extend.

1. A device for evaluating and/or influencing a movement variable of a vehicle and/or a movement behavior of the vehicle, the device comprising:
operator control means by which a driver generates predefined values for influencing at least one vehicle movement variable,
evaluation means with which at least one of: a behavior of a vehicle movement variable is evaluated with respect to a predefined value, and a vehicle movement behavior is evaluated with respect to a predefined vehicle movement behavior as a function of at least one of vehicle movement variables and variables which represent surroundings of the vehicle,
said evaluation means being capable of operating in at least two different operating states,
wherein an information item relating to the behavior of the vehicle movement variable and/or relating to the vehicle movement behavior being made available in a first operating state to the driver as a function of the result of the evaluation which is carried out, and output signals for influencing a vehicle movement variable and/or the vehicle movement behavior independently of the driver being determined in a second operating state as a function of the result of the evaluation which is carried out,
influencing means by which the driver can switch over the evaluation means between the at least two operating states, and
processing means by which actuation signals for actuating actuators, which are arranged in the vehicle, are generated on the basis of the predefined variables which are generated by the driver and/or, if the evaluation means are operated in the second operating state, on the basis of the output signals, wherein the vehicle movement variable and/or the vehicle movement behavior is influenced by the actuation of the actuators.

2. The device as claimed in claim 1, wherein a plurality of sub-operating states of the evaluation means are selectable using the influencing means in the second operating state of the evaluation means, said sub-operating states being distinguished from one another by a priority relationship between the output signals and the predefined values in the determination of the actuation signals.

3. The device as claimed in claim 2, wherein, in a first sub-operating state, the driver can select between two operating modes:
a first operating mode in which the output signals are not taken into account in the generation of the actuation signals, or the determination of the output signals is suppressed so that they are not at all available in the generation of the actuation signals, and
a second operating mode in which the output signals are taken into account in the generation of the actuation signals, the predefined values basically having priority over the output signals in the generation of the actuation signals, unless a predefined first situation is present in which the output signals then have priority over the predefined values.

4. The device as claimed in claim 3, the predefined first situation is present if at least one of: the vehicle movement variable deviates from the predefined value to a predetermined degree, and the vehicle movement behavior deviates from the predefined vehicle movement behavior to a predefined degree.

5. The device as claimed in claim 2, wherein in a second sub-operating state, the output signals basically have priority over the predefined values in the generation of the actuation signals unless a predetermined second situation is present in which the predefined values then have priority over the output signals.

6. The device as claimed in claim 5, wherein the predetermined second situation is present if the driver activates one of the operator control means in a fashion which is characteristic of the second sub-operating state.

7. The device as claimed in claim 2, wherein in a third sub-operating state, the predefined values are not taken into account in the generation of the actuation signals, and further wherein, in said third sub-operating state, the output signals are determined redundantly and the actuation signals are determined on the basis of these redundantly determined output signals.

8. The device as claimed in claim 2, wherein in a third sub-operating state, the actuation signals are generated independently of the driver using autonomously operating, redundantly configured evaluation means.

9. The device as claimed in claim 1, wherein said actuators include at least one of actuators for the brake system, the steering system, the engine, the transmission.

10. The device as claimed in claim 1, wherein the device is subdivided with respect to the signal processing into individual signal processing levels, the following signal processing levels being provided:
an input level (E1) to which the operator control means with which the driver can continuously make predefined inputs which are converted into predefined values are assigned, and to which the influencing means are assigned,
at least one of a predictive level (P) with first processing means for correcting the predefined values by means of a prediction of driving states which is made by first evaluation means and a reactive level (R) with second processing means for correcting the predefined values by using current driving states which are determined by second evaluation means,
a coordination level (K) with third processing means for converting the predefined values into actuation signals, and
an execution level (F) with the actuators for executing the actuation signals.

11. The device as claimed in claim 10, wherein the reactive level is arranged between the coordination level and the execution level.

12. The device as claimed in claim 10, wherein a reactive processing means for reacting to critical current driving states is directly assigned to at least one actuator.

13. The device as claimed in claim 10, wherein power supply units for supplying power to all of the signal processing levels are embodied redundantly.

14. The device as claimed in claim 10, wherein, in the predictive level (P), the reactive level (R) and the coordination level (K), in each case at least two physically separate first processing means, second processing means or third processing means are provided for redundant signal processing.

15. The device as claimed in claim 1, wherein the actuators are connected to the third processing means and to one another by a fault-tolerant, redundant and bidirectional data bus, and wherein at least one of the first processing means, the second processing means and the third processing means are configurable for redundant signal processing, and further wherein apparatuses for fault-tolerant, redundant and bidirectional data transmission are provided between two successive signal processing levels.
